(19) United States
(12) Patent Application Publication
(10) Pub. No.: US 2026/0300298 A1
(43) Pub. Date: Oct. 1, 2026

(54) BLOCKCHAIN RANGE SUM QUERY

(71) Applicant: Tencent Technology (Shenzhen) Company Limited, Shenzhen (CN)

(72) Inventors: Guanghong LU, Shenzhen (CN); Zhihong CAI, Shenzhen (CN)

(73) Assignee: Tencent Technology (Shenzhen) Company Limited, Shenzhen, GD (CN)

(21) Appl. No.: 19/678,884

(22) Filed: May 15, 2026

Related U.S. Application Data
(63) Continuation of application No. PCT/CN2025/083788, filed on Mar. 20, 2025.

(30) Foreign Application Priority Data
Apr. 10, 2024 (CN) 202410444477.2

(51) Int. Cl. G06F 16/2455; G06F 16/901

(52) U.S. Cl. CPC G06F 16/2455; G06F 16/9024

(57) ABSTRACT

In a data processing method, a data query request configured to query block data located within a target block range [i, j] in a blockchain is obtained. A block prefix sum array corresponding to the blockchain and including at least one block prefix sum is obtained. Each block prefix sum is associated with a respective block height in the blockchain, and is configured to store block data of a block corresponding to the associated block height and block data of a block corresponding to a block height preceding the associated block height. A first block prefix sum associated with a block height (i−1) and a second block prefix sum associated with the block height j are determined from the block prefix sum array. The block data is generated based on block data stored in the first block prefix sum and the second block prefix sum, respectively.

### RELATED APPLICATIONS

The application is a continuation of International Application No. PCT/CN2025/083788, filed on Mar. 20, 2025, which claims priority to Chinese Patent Application No. 202410444477.2, filed on Apr. 10, 2024, and entitled “DATA PROCESSING METHOD AND APPARATUS, COMPUTER DEVICE, AND STORAGE MEDIUM.” The entire disclosures of the prior applications are hereby incorporated by reference.

### FIELD OF THE TECHNOLOGY

This disclosure relates to the field of computer technologies, including a data processing method and apparatus, a computer device, and a storage medium.

### BACKGROUND OF THE DISCLOSURE

Based on data security and immutability of a blockchain network, an increasing amount of data is stored in a manner of on-chain storage. After the data is on-chain stored, a currently provided query manner is to traverse an entire blockchain or rely on an external database to perform data synchronization to implement query. Such query manner is particularly inefficient, and when data query relates to a large quantity of blocks, query time further increases, leading to a severe degradation in query performance. Therefore, it can be learned that, after the data is on-chain stored, how to improve efficiency of data query in the blockchain becomes a currently popular research topic.

### SUMMARY

Embodiments of this disclosure include a data processing method and apparatus, a computer device, and a storage medium, to improve efficiency of data query in a blockchain.

According to an aspect, a data processing method is provided. In the data processing method, a data query request is obtained. The data query request is configured to query block data located within a target block range [i, j] in a blockchain, both i and j indicating block heights, both i and j being positive integers, and j>i. A block prefix sum array corresponding to the blockchain is obtained. The block prefix sum array includes at least one block prefix sum, each block prefix sum being associated with a respective block height in the blockchain, and each block prefix sum being configured to store block data of a block corresponding to the associated block height and block data of a block corresponding to a block height preceding the associated block height. From the block prefix sum array, a first block prefix sum associated with a block height (i−1) and a second block prefix sum associated with the block height j are determined. Based on block data stored in the first block prefix sum and block data stored in the second block prefix sum, the block data located within the target block range [i, j] in the blockchain is generated.

According to an aspect, a data processing device is provided. The data processing device includes processing circuitry configured to obtain a data query request, the data query request being configured to query block data located within a target block range [i, j] in a blockchain, both i and j indicating block heights, both i and j being positive integers, and j>i. The processing circuitry is configured to obtain a block prefix sum array corresponding to the blockchain, the block prefix sum array including at least one block prefix sum, each block prefix sum being associated with a respective block height in the blockchain, and each block prefix sum being configured to store block data of a block corresponding to the associated block height and block data of a block corresponding to a block height preceding the associated block height. The processing circuitry is configured to determine, from the block prefix sum array, a first block prefix sum associated with a block height (i−1) and a second block prefix sum associated with the block height j. The processing circuitry is configured to generate, based on block data stored in the first block prefix sum and block data stored in the second block prefix sum, the block data located within the target block range [i, j] in the blockchain.

According to an aspect, a non-transitory computer-readable storage medium is provided. The non-transitory computer-readable storage medium storing instructions which when executed by at least one processor cause the at least one processor to perform any of the data processing methods.

According to an aspect, an embodiment of the present disclosure provides a data processing method, including:
obtaining a data query request, the data query request being configured to request query of block data located within a target block range [i, j] in a blockchain, both i and j indicating block heights, both i and j being positive integers, and j>i;
obtaining a block prefix sum array corresponding to the blockchain, the block prefix sum array including at least one block prefix sum, any block prefix sum being associated with a block height in the blockchain, and any block prefix sum being configured to store block data of a block corresponding to the associated block height and block data of a block corresponding to a block height preceding the associated block height;
determining, from the block prefix sum array, a first block prefix sum associated with a block height (i−1) and a second block prefix sum associated with a block height j; and
generating, based on block data stored in the first block prefix sum and block data stored in the second block prefix sum, block data that is requested to be queried by the data query request.

According to another aspect, an embodiment of the present disclosure provides a data processing apparatus, including:
an obtaining unit, configured to obtain a data query request, the data query request being configured to request query of block data located within a target block range [i, j] in a blockchain, both i and j indicating block heights, both i and j being positive integers, and j>i;
the obtaining unit, further configured to obtain a block prefix sum array corresponding to the blockchain, the block prefix sum array including at least one block prefix sum, any block prefix sum being associated with a block height in the blockchain, and any block prefix sum being configured to store block data of a block corresponding to the associated block height and block data of a block corresponding to a block height preceding the associated block height;
a processing unit, configured to determine, from the block prefix sum array, a first block prefix sum associated with a block height (i−1) and a second block prefix sum associated with a block height j; and
the processing unit, further configured to generate, based on block data stored in the first block prefix sum and block data stored in the second block prefix sum, block data that is requested to be queried by the data query request.

According to another aspect, an embodiment of the present disclosure provides a computer device, including a processor, an input device, an output device, and a memory, the processor, the input device, the output device, and the memory being connected to each other, the memory being configured to store a computer program that supports a terminal (e.g., the computer device) in performing the foregoing method, the computer program including program instructions, and the processor being configured to invoke the program instructions, to perform the following operations:
obtaining a data query request, the data query request being configured to request query of block data located within a target block range [i, j] in a blockchain, both i and j indicating block heights, both i and j being positive integers, and j>i;
obtaining a block prefix sum array corresponding to the blockchain, the block prefix sum array including at least one block prefix sum, any block prefix sum being associated with a block height in the blockchain, and any block prefix sum being configured for storing block data of a block corresponding to the associated block height and block data of a block corresponding to a block height preceding the associated block height;
determining, from the block prefix sum array based on a target block range, a first block prefix sum associated with a block height (i−1) and a second block prefix sum associated with a block height j; and
generating, based on block data stored in the first block prefix sum and block data stored in the second block prefix sum, block data that is requested to be queried by the data query request.

According to another aspect, an embodiment of the present disclosure provides a non-transitory computer-readable storage medium, having computer instructions stored thereon, the computer instructions, when executed by a processor, performing the data processing method according to the first aspect.

According to another aspect, an embodiment of the present disclosure provides a computer program product, including a computer program or computer instructions, the computer program or the computer instructions, when executed by a processor, performing the data processing method according to the first aspect.

In embodiments of this disclosure, when performing data query in a blockchain, a computer device may first obtain a data query request, to determine a target block range within which to-be-queried data is located. In addition, the computer device may further obtain a block prefix sum array corresponding to the blockchain, to separately determine, from the block prefix sum array based on the target block range, a first block prefix sum and a second block prefix sum that are associated with the target block range. Based on the determining of the first block prefix sum and the second block prefix sum by the computer device, the computer device can determine, based on data stored in the first block prefix sum and data stored in the second block prefix sum, data requested by the data query request. Therefore, the computer device implements quick query of block data within different block ranges in the blockchain based on the block prefix sum array, and improves efficiency of querying blockchain data. In addition, by querying the blockchain data based on the block prefix sum array, the computer device can obtain queried block data within constant time regardless of a size of the query range when querying data, to reduce complexity of querying of the block data by the computer device. Based on improvement in efficiency and reduction in complexity of querying of the blockchain data by the computer device, stability and reliability of a system for querying of the blockchain data by the computer device can be more effectively ensured.

### BRIEF DESCRIPTION OF THE DRAWINGS

FIG. 1A is a schematic diagram of a data sharing system according to an embodiment of this disclosure.

FIG. 1B is a schematic diagram of block data according to an embodiment of this disclosure.

FIG. 1C is a schematic diagram of a data processing system according to an embodiment of this disclosure.

FIG. 2 is a schematic flowchart of a data processing method according to an embodiment of this disclosure.

FIG. 3A is a schematic diagram of a block prefix sum array according to an embodiment of this disclosure.

FIG. 3B is a schematic diagram of determining block sizes of block prefix sums according to an embodiment of this disclosure.

FIG. 3C is a schematic diagram of performing data query based on a target block range according to an embodiment of this disclosure.

FIG. 3D is a schematic diagram of a system of a computer device according to an embodiment of this disclosure.

FIG. 4 is a schematic flowchart of a data processing method according to an embodiment of this disclosure.

FIG. 5A is a schematic diagram of determining data that is requested to be queried according to an embodiment of this disclosure.

FIG. 5B is another schematic diagram of determining data that is requested to be queried according to an embodiment of this disclosure.

FIG. 5C is a schematic diagram of merging block prefix sums according to an embodiment of this disclosure.

FIG. 5D is another schematic diagram of merging block prefix sums according to an embodiment of this disclosure.

FIG. 6A is a schematic diagram of generating a new block as a prefix sum array according to an embodiment of this disclosure.

FIG. 6B is a schematic diagram of merging prefix sum arrays according to an embodiment of this disclosure.

FIG. 7 is a schematic diagram of performing data query based on a prefix sum array according to an embodiment of this disclosure.

FIG. 8 is a schematic block diagram of a data processing apparatus according to an embodiment of this disclosure.

FIG. 9 is a schematic block diagram of a computer device according to an embodiment of this disclosure.

### DETAILED DESCRIPTION

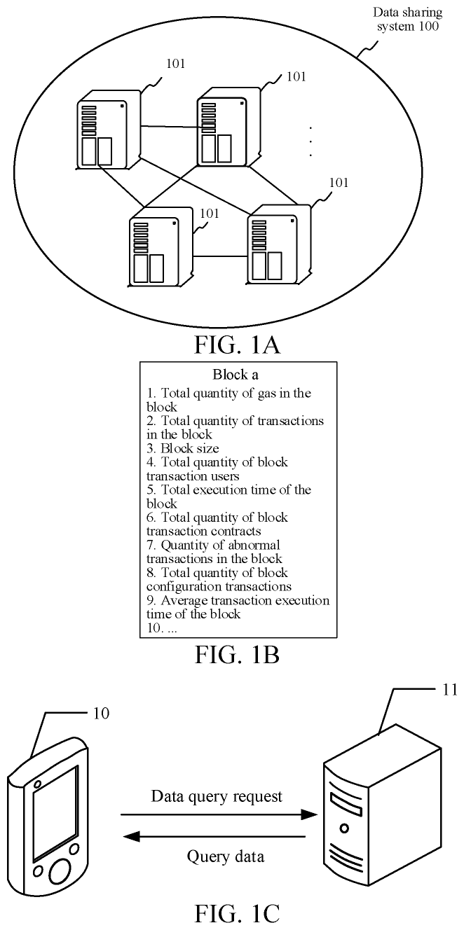

Embodiments of this disclosure provide a blockchain-based data processing method. A computer device may query block data located within a target block range in a blockchain based on a stored block prefix sum array, so that the computer device efficiently queries the block data in the blockchain based on the block prefix sum array. The computer device is any node device in a blockchain network. The blockchain network may be a data sharing system shown in FIG. 1A. The data sharing system 100 is a system configured to share data between nodes. The system may include a plurality of nodes, for example, nodes identified with 101 in FIG. 1A, and any node may be a client in the data sharing system. Each node 101 may receive input information during normal work, and maintain shared data in the data sharing system based on the received input information. Each node 101 in the data sharing system 100 may implement data sharing between different nodes 101 by maintaining the blockchain. In an example, the blockchain is a decentralized database, and is a string of associated data blocks generated by using a cryptographic method. Each data block (or block) includes related transaction data. The blockchain is a distributed ledger technology in the field of information technologies, and includes content such as consensus, transaction block, status data storage, and cryptographic identity security. Because the ledger is stored in a distributed manner and blocks are generated through consensus, the blockchain has features such as immutability, traceability, and joint maintenance. In addition, each block further includes quantity information in a transaction execution process, such as a total quantity of transactions and a total quantity of gas (a type of digital resource) of the block. The quantity information in each block may include various quantity information shown in FIG. 1B.

The block prefix sum array in embodiments of this disclosure applies an idea of a prefix sum array to a blockchain technology. The prefix sum array is a data structure configured to store a cumulative sum of any target sequence, so that a sum of any range in the target sequence can be quickly calculated based on the cumulative sum stored in the prefix sum array. If a target sequence is arr[ ], which includes elements arr[0] to arr[n], where n is a positive integer, a sum of elements obtained by accumulating first i elements of the target sequence may be represented as an array prefixSum[ ], where i is an integer greater than or equal to 0 and less than n. The cumulative sum obtained by accumulating the first i elements of the target sequence is represented as: prefixSum[i]=arr[0] to arr[i], that is, the array prefixSum[ ] is a prefix sum array of the target sequence arr[ ]. The block prefix sum array is an array including prefix sums of block data.

The target block range in the blockchain is a range of a block with a corresponding block height between two heights. For example, the target block range is [2, 5], and the target block range represents a block range of blocks from a block with a corresponding block height 2 to a block with a corresponding block height 5. In this case, querying data located within the target block range in the blockchain based on the block prefix sum array is a process of querying a block range sum based on the block prefix sum array. In an embodiment, the block range sum is a sum of data (such as a transaction volume, gas consumption, and a quantity of transactions) of consecutive blocks within a specific range in the blockchain, for example, a total transaction volume of the 100^{th} block to the 200^{th} block. In this case, when the computer device queries, based on the block prefix sum array, data located within the target block range in the blockchain, if the target block range that is to be queried is [i, j], and the prefix sum array is represented by the foregoing array prefixSum[ ], a total data amount of the target block range [i, j] may be represented as prefixSum[j]−prefixSum[i−1].

In an embodiment, because a key feature of the prefix sum array is that a sum of any range [i, j] can be calculated within constant time (that is, with complexity of O(1)), efficiency of querying the total data amount (or a sum of data) in the blockchain by the computer device can be effectively improved by using the data processing method in embodiments of this disclosure, so that efficient querying of blockchain data is implemented. In other words, querying the block range sum by using the block prefix sum array can improve effectiveness of querying. In addition, because complexity of querying the prefix sum array is a constant, efficiency of summing and querying a large quantity of data ranges by using the prefix sum array by the computer device is significantly improved. Algorithm complexity is a criterion for measuring algorithm execution efficiency, and usually includes time complexity and space complexity. The time complexity refers to a calculation workload required for executing an algorithm, and the space complexity refers to storage space required for executing the algorithm. The algorithm complexity is usually represented by a capital letter O (O-notation). For example, the algorithm complexity may be represented as O(1), O(n), or O(n²), where n represents a size of input data. In this case, O(1) represents that execution time of the algorithm does not increase as the input data increases, that is, represents constant time complexity, O(n) represents that the execution time of the algorithm linearly increases as the input data increases, and O(n²) represents that the execution time of the algorithm exponentially increases as the input data increases. Therefore, in embodiments of this disclosure, the algorithm complexity of querying the block range sum by using the block prefix sum array is O(1). This may indicate that time consumption of data query by using this algorithm has the constant time complexity, representing an ideal state.

When the computer device performs data query in the blockchain based on the block prefix sum array, after obtaining a data query request, the computer device may determine a corresponding block prefix sum from the block prefix sum array based on the target block range indicated by the data query request, to determine, based on the determined block prefix sum, data that is to be queried (e.g., data that is requested to be queried). In an embodiment, the blockchain-based data processing method may be applied to a data processing system shown in FIG. 1C. The data processing system includes a query device 10, that is, a device in which a query user is located, and a computer device 11. The computer device 11 is any node device in a blockchain network. Then, the query device 10 may send the data query request to the blockchain network, so that the computer device 11 can obtain the data query request from the blockchain network, and determine, based on the data query request and with reference to the block prefix sum array, the data that is requested to be queried. The determined data that is requested to be queried may also be returned to the query device 10. In an embodiment, the query device 10 may be a terminal device, and the computer device may be a terminal device, or may be a server. The terminal device includes, but is not limited to devices such as a smartphone, a tablet computer, an intelligent wearable device, an intelligent voice interaction device, an intelligent appliance, a personal computer, and an on-board terminal. This is not limited in this disclosure. A quantity of terminal devices is not limited in this disclosure. The server may be an independent physical server; a server cluster or distributed system including a plurality of physical servers; or may be a cloud server providing basic cloud computing services such as a cloud service, a cloud database, cloud computing, a cloud function, cloud storage, a network service, cloud communication, a middleware service, a domain name service, a security service, a content delivery network (CDN), and big data and an artificial intelligence platform, but is not limited thereto. Similarly, a quantity of servers is not limited in this disclosure.

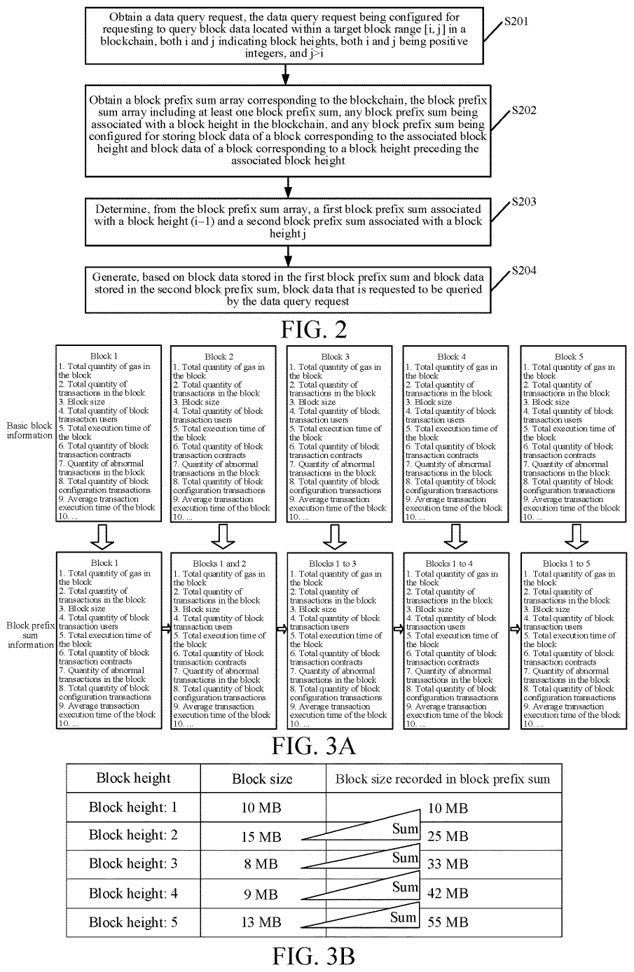

FIG. 2 is a schematic flowchart of a blockchain-based data processing method according to an embodiment of this disclosure. As shown in FIG. 2, the method may include the following operations.

S201: Obtain a data query request, the data query request being configured for requesting to query block data located within a target block range [i, j] in a blockchain, both i and j indicating block heights, both i and j being positive integers, and j>i. In an example, the data query request is a request used to query the block data located within the target block range [i, j] in the blockchain.

S202: Obtain a block prefix sum array corresponding to the blockchain, the block prefix sum array including at least one block prefix sum, any block prefix sum being associated with a block height in the blockchain, and any block prefix sum being configured for storing block data of a block corresponding to the associated block height and block data of a block corresponding to a block height preceding the associated block height.

In operation S201 and operation S202, when querying a block range sum data in the blockchain, a computer device performs query based on the stored block prefix sum array. In this case, the following describes an example of obtaining the block prefix sum array corresponding to the blockchain. In an embodiment, the block prefix sum array includes at least one block prefix sum. The block prefix sum may be associated with a block height in the blockchain and be configured for storing a sum of block data of a block corresponding to the associated height and block data of a preceding block corresponding to a height preceding the associated height. In other words, the block prefix sum may be configured for storing the block data of the block corresponding to the associated block height and the block data of the block corresponding to the block height preceding the associated block height. In an example, a block prefix sum associated with a first block height indicates a data sum of first block data of a first block corresponding to the first block height and block data of one or more blocks corresponding to respective block height(s) preceding the first block height.

A block corresponding to a block height is a block with the block height, and a block height preceding a block height may be any block height with a value less than the block height. To be specific, if a block prefix sum in the block prefix sum array is associated with a block height of 5, the block prefix sum is configured for storing block data of a block with a corresponding block height 5 in the blockchain and block data of blocks with block heights preceding the block height 5 (that is, blocks with block heights 1 to 4). In other words, the block prefix sum associated with the block height 5 is configured for storing a data sum of data of the blocks with the block heights 1 to 5.

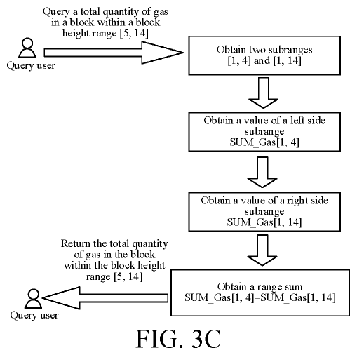

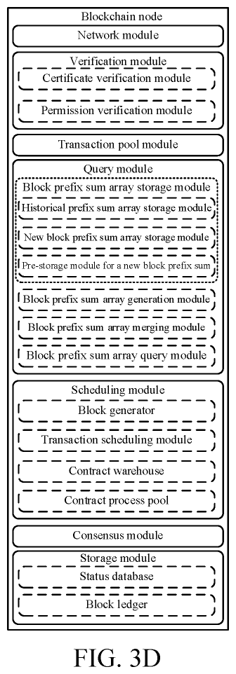

Based on examples of generating the block prefix sum, the computer device may obtain (e.g., separately obtain), based on block heights in the blockchain, a block prefix sum associated with any block height, and the block prefix sum associated with any block height is block prefix sum data corresponding to the blockchain. In an embodiment, if the blockchain includes five blocks, and block heights corresponding to the five blocks are respectively 1 to 5, when generating the block prefix sum array corresponding to the blockchain, the computer device may also respectively generate block prefix sums associated with the block heights, to obtain the block prefix sum array corresponding to the blockchain. The block prefix sum array includes the block prefix sums respectively associated with the block heights. The blockchain including blocks with the corresponding block heights 1 to 5 and the corresponding prefix sum array may be shown in FIG. 3A. Basic block information in FIG. 3A includes blocks with the corresponding block heights 1 to 5. A block 1 in FIG. 3A is a block with the corresponding block height 1 in the blockchain, a block 2 is a block with the corresponding block height 2 in the blockchain, and so on. Block prefix sum information in FIG. 3A indicates the block prefix sum array corresponding to the blockchain. As shown in FIG. 3A, the block 1 in the block prefix sum array includes block data of a block (that is, the block 1) with the block height 1 in the blockchain, and the block 1 and the block 2 include a sum of block data of blocks with block heights 1 and 2 in the blockchain. By analogy, a data representation of each block prefix sum in the block prefix sum array may be described.

In an embodiment, block prefix sum data of a corresponding block in the blockchain may be stored in a block structure shown in FIG. 3A. In other words, each block prefix sum in the block prefix sum array may also be stored as a block. In another implementation, each block prefix sum in the block prefix sum array may alternatively be stored in another form, for example, may be stored in a form such as a number table. When stored in the form of the number table, one-to-one correspondence between a block prefix sum and a number table may alternatively be used for storage, and different block prefix sums may be stored in different number tables, to distinguish between different block prefix sums. Block range lengths represented by the block prefix sums associated with the block heights in the block prefix sum array in the blockchain shown in FIG. 3A may be shown in Table 1.

TABLE 1

| | Range length |
|---|---|
| Block height: 1 | [1] |
| Block height: 2 | [1, 2] |
| Block height: 3 | [1, 3] |
| Block height: 4 | [1, 4] |
| Block height: 5 | [1, 5] |

As shown in FIG. 3A, a data type of data included in each block prefix sum in the block prefix sum array is the same as a data type of data included in each block in the blockchain, but values of the corresponding data are different. Because the block prefix sum in the block prefix sum array corresponding to the blockchain is configured for storing the sum of the data of the block corresponding to the associated block height and the data of the preceding block, and a sum of data of preceding blocks corresponding to block heights preceding the block height associated with the block prefix sum is stored in a block prefix sum preceding the block prefix sum, when calculating a block prefix sum other than the 1^{st} block prefix sum in the block prefix sum array, for example, when calculating the 3^{rd} block prefix sum in the block prefix sum array, the computer device may first obtain a to-be-calculated block prefix sum (for example, the 3^{rd} block prefix sum) and block data (where it is assumed that the block data is a) of a block with a block height (where the block height is 3) associated with the to-be-calculated block prefix sum, and then obtain data (where it is assumed that the stored data is b) stored in a block prefix sum (that is, the 2^{nd} block prefix sum) preceding the to-be-calculated block prefix sum. In this way, the computer device may determine that the to-be-calculated block prefix sum is a sum of data of the block data of the associated block height and data of the preceding block prefix sum, that is, a+b.

In other words, data of the to-be-calculated block prefix sum in the block prefix sum array is equal to a sum of data of a current block and data of a preceding block prefix sum. The current block is a block corresponding to the block height associated with the to-be-calculated block prefix sum, and the data in the block prefix sum includes data of various data types shown in FIG. 1B, such as a block size and a total volume of block transactions. In an example, the data of the block prefix sum is the block size, as shown in FIG. 3B, if the blockchain is the blockchain in FIG. 3A, values of the block sizes recorded in block prefix sums in the block prefix sum array may be as shown in FIG. 3B.

In embodiments of this disclosure, block data recorded in each block includes: data related to generation of a corresponding block and data related to transaction data in the block. In this case, different generation processes of different blocks and different execution situations of the transaction data may cause differences in related data recorded in the blocks. In an embodiment, block data recorded in a block further includes different data types. As shown in FIG. 1B, the block data recorded in the block includes data indicating a type of a total quantity of gas, data indicating a type of a total quantity of transactions, data indicating a block size, and the like. When the computer device generates the block prefix sum array, a data type included in each block prefix sum is the same as a data type included in the block. Therefore, when obtaining the types of data in the block prefix sum, the computer device adds data corresponding to the same type in corresponding blocks to obtain a sum of data. As shown in FIG. 3A, a total quantity of transactions in the block recorded in the block 1 to the block 3 in the block prefix sum information is a sum of the total quantity of transactions in the block 1, a total quantity of transactions in the block 2, and a total quantity of transactions in the block 3, and is also a sum of the total quantity of transactions in the block recorded in the block 1 and the block 2 and the total quantity of transactions in the block 3.

Based on the foregoing manner of generating the block prefix sum in the block prefix sum array, the computer device may query data within a block range in the blockchain based on the block prefix sum array. In a specific implementation, the computer device may first obtain the data query request. The data query request instructs to query data within a target block range [i, j] in the blockchain. i and j both represent block heights in the blockchain and are both positive integers. For example, if the target block range is [1, 2], a sum of data of a block with a block height 1 and a block with a block height 2 is requested to be queried, and if the target block range is [2, 8], a sum of all block data from a block with the block height 2 to a block with a block height 8 is requested to be queried. In addition, the target block range [i, j] further meets j>i. However, in a case that j=i, [i, j] indicates a specific block in the blockchain. For example, [1, 1] represents the 1^{st} block in the blockchain, and [3, 3] represents the 3^{rd} block in the blockchain. The case that i=j is also applicable to embodiments of this disclosure.

The computer device obtains the data query request from a query device, and the query device is a device in which a query user is located. In an example, after determining a to-be-queried block range, the query user may package and encapsulate information such as the to-be-queried block range and to-be-queried content by using the query device. The to-be-queried content refers to a data type of the to-be-queried data, for example, the total quantity of gas in the block and the total quantity of transactions in the block described above. After packaging and encapsulation are completed, the query user may perform signature processing on the packaged content, and then transmit the packaged content and the signature to a blockchain node (that is, the computer device). The computer device may receive the packaged content and signature information of the query user, and then may perform certificate and signature verification. After the verification succeeds, the computer device obtains the to-be-queried block range from the packaged content, and performs a subsequent query process. When obtaining the packaged content and the signature information, the computer device obtains the data query request.

After the computer device determines, based on the data query request, the target block range [i, j] that is to be queried, the computer device may further obtain the block prefix sum array corresponding to the blockchain, to obtain, based on each block prefix sum in the block prefix sum array, block data that is requested to be queried. In a specific implementation, after determining the target block range [i, j] that is to be queried, the computer device may obtain, from a sparse table, the block prefix sum array corresponding to the blockchain; then determine, from the obtained block prefix sum array based on the target block range [i, j], a first block prefix sum associated with a block height (i−1) and a second block prefix sum associated with a block height j; and then generate, based on the determined first block prefix sum and second block prefix sum, data that is requested to be queried. Then operation S203 may be performed.

S203: Determine, from the block prefix sum array, the first block prefix sum associated with the block height (i−1) and the second block prefix sum associated with the block height j.

S204: Generate, based on block data stored in the first block prefix sum and block data stored in the second block prefix sum, block data that is requested to be queried by the data query request.

In operation S203 and operation S204, when determining the block data within the target block range [i, j] based on the block prefix sum array, the computer device may determine, from the block prefix sum array, the first block prefix sum associated with the block height (i−1) and the second block prefix sum associated with the block height j; and then calculate difference data between sums of data respectively recorded in the two block prefix sums. The difference data may be referred to as first difference data. The first difference data may be additional block data in the second block prefix sum associated with the block height j compared to the block data in the first block prefix sum associated with the block height (i−1). The first difference data obtained through calculation may be used as the block data that is requested to be queried by the data query request. However, when i is equal to 1, i−1 is 0, and there is no block prefix sum associated with a block height 0 in the block prefix sum array, the first block prefix sum may not be obtained. Therefore, when i=1, the computer device may obtain only the second block prefix sum associated with the block height j, and may use the block data stored in the obtained second block prefix sum as the block data that is requested to be queried by the data query request. When i is not equal to 1, i−1 is greater than 0. Therefore, the computer device may obtain, based on the obtained first block prefix sum and second block prefix sum, the block data that is requested to be queried by the data query request.

In an embodiment, a process in which the computer device determines, based on the block prefix sum array and the target block range [i, j] indicated by the data query request, the block data that is requested to be queried may be shown in FIG. 3C. A data type of the to-be-queried data is a total quantity of gas in the block. In this case, operations specifically performed by the computer device include the following operation 1 to operation 5.

1: Obtain the target block range [5, 14] and determine that the to-be-queried content is the total quantity of gas in the block.

2: Determine two sub-ranges, that is, [1, 4] and [1, 14], based on the target block range, where [1, 4] is a left sub-range, and [1, 14] is a right sub-range.

3: Obtain the first block prefix sum corresponding to the left sub-range [1, 4], and obtain a corresponding total quantity 1 of gas in the block, that is, SUM_Gas [1, 4], from the first block prefix sum; and obtain the second block prefix sum corresponding to the right sub-range [1, 14], and obtain a corresponding total quantity 2 of gas in the block, that is, SUM_Gas [1, 14], from the second block prefix sum.

4: Perform difference calculation based on the total quantity 1 of gas in the block stored in the first block prefix sum and the total quantity 2 of gas in the block stored in the second block prefix sum, to obtain a total quantity of gas in the block within the target block range [5, 14].

5: Use the obtained total quantity of gas in the block as queried data and return the queried data to the query user.

A process in which the computer device queries block data by using the block prefix sum array may be applied to the following several application scenarios.

1. Financial transaction analysis scenario: In the financial service field, such as a cipher currency exchange or a decentralized financial (DeFi) platform, indicators such as a transaction volume, transaction fees (gas consumption), and user activeness are to be analyzed in real time. Based on the method provided in embodiments of this disclosure, the computer device may quickly determine accumulated data in a particular historical time period based on the prefix sum array, to help an analyst make a more accurate transaction decision more quickly.

2. Supply chain management scenario: In the supply chain management scenario, an enterprise is to obtain each link from production to transaction of a product. Therefore, according to embodiments of this disclosure, a computer device of an enterprise party may quickly query a transaction record and related data in a specific time period by using the prefix sum array, to ensure transparency and efficiency of a supply chain.

3. Data service provider scenario: A computer device corresponding to a data service provider may provide an efficient blockchain data query service by using embodiments of this disclosure. For example, historical data analysis and reports may be provided for market research, business intelligence, and the like based on the data stored in the prefix sum array.

4. Smart contract audit scenario: A smart contract is a computer protocol aimed at propagation, verification, or execution of a contract in an informative manner, allows trusted transactions to be performed without a third party, and these transactions is searchable and irreversible. Therefore, security of the smart contract is crucial. When analyzing a contract behavior of the contract within a specific time period, an auditor may quickly obtain, by using a corresponding computer device and by using the block prefix sum array in embodiments of this disclosure, historical data during execution of the smart contract, to help the auditor detect a potential security problem of the smart contract.

5. Voting and governance system scenario: In a blockchain-based voting and governance system, if statistics on voting behaviors and participation in a particular time period are collected, a computer device may provide these statistics data based on the prefix sum array in embodiments of this disclosure, to ensure transparency and correctness of a governance process.

6. Real-time viewing and alarm system scenario: For an application that obtains a blockchain network status in real time, such as a security check system and an abnormal behavior detection system, a computer device may provide fast data access based on embodiments of this disclosure, to immediately trigger an alarm when an abnormal behavior is detected.

7. Blockchain analysis tool scenario: A developer and a researcher may develop a blockchain analysis tool by using a computer device based on embodiments of this disclosure, to quickly obtain and analyze various data in a blockchain, so that research efficiency and depth are improved.

Applications of embodiments of this disclosure in the foregoing different application scenarios reflect wide applicability of embodiments of this disclosure to different industries and fields. In particular, in applications that use efficient and real-time data access and analysis, features of obtaining data by using embodiments of this disclosure are particularly apparent. Therefore, querying data based on a block prefix sum array can significantly improve performance of processing blockchain data, and provide a service of higher value for users and enterprises.

In embodiments of this disclosure, when performing data query in a blockchain, a computer device may first obtain a data query request, to determine a target block range within which to-be-queried data is located. In addition, the computer device may further obtain a block prefix sum array corresponding to the blockchain, to separately determine, from the block prefix sum array based on the target block range, a first block prefix sum and a second block prefix sum that are associated with the target block range. Based on the determining of the first block prefix sum and the second block prefix sum by the computer device, the computer device can determine, based on data stored in the first block prefix sum and data stored in the second block prefix sum, data requested by the data query request. Therefore, the computer device implements quick query of block data within different block ranges in the blockchain based on the block prefix sum array, and improves efficiency of querying blockchain data. In addition, by querying the blockchain data based on the block prefix sum array, the computer device can obtain block data that is requested to be queried within constant time regardless of a size of the query range when querying data, to effectively reduce complexity of querying of the block data by the computer device. Based on effective improvement in efficiency and effective reduction in complexity of querying of the blockchain data by the computer device, stability and reliability of a system for querying of the blockchain data by the computer device can be effectively ensured.

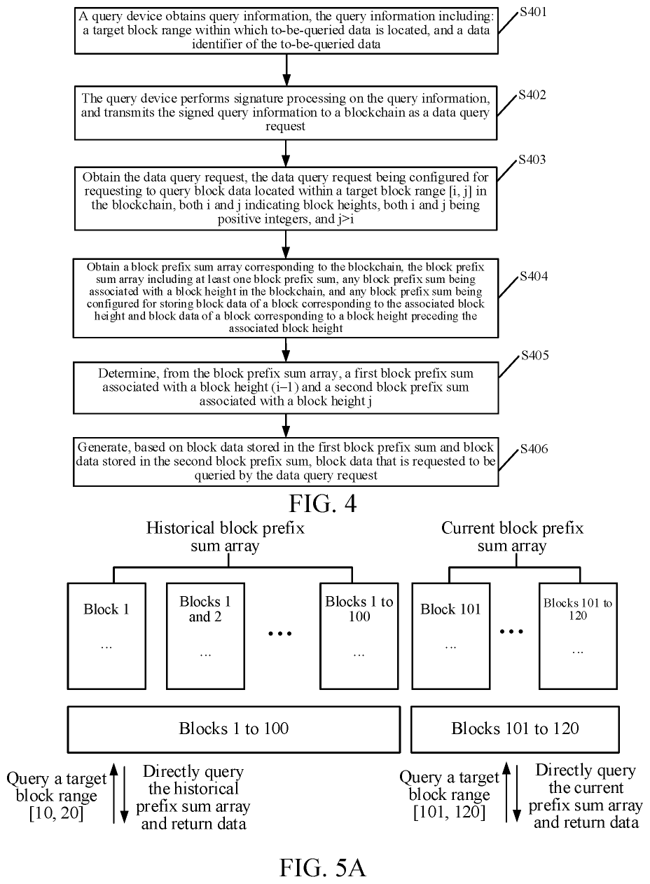

FIG. 4 shows a blockchain-based data processing method according to an embodiment of this disclosure. This embodiment of this disclosure describes a full-period procedure of a high-performance blockchain range sum query solution of multi-level prefix sum array storage. In an example, the procedure includes a block prefix sum array generation procedure corresponding to a blockchain (that is, an entire procedure of generating a range prefix sum array when a new block is produced in the blockchain), a block multi-level prefix sum array merging procedure corresponding to the blockchain (that is, a merging and refreshing procedure of new block prefix sum array storage to historical block prefix sum array storage), and a multi-level prefix sum array query procedure within a blockchain range (that is, a query interaction procedure in which a user queries a blockchain for a sum of block ranges). As shown in FIG. 4, the method may include the following operations.

S401: A query device obtains query information, the query information including: a target block range within which to-be-queried data is located, and a data identifier of the to-be-queried data.

S402: The query device performs signature processing on the query information, and transmits the signed query information to the blockchain as a data query request.

S403: Obtain the data query request, the data query request being configured for requesting to query block data located within a target block range [i, j] in the blockchain, both i and j indicating block heights, both i and j being positive integers, and j>i.

In operation S401 to operation S403, the data query request obtained by a computer device is obtained from a blockchain network after being transmitted by the query device to the blockchain network. When transmitting the data query request to the blockchain network, the query device may first obtain the query information, which includes the target block range within which the to-be-queried data is located and the data identifier of the to-be-queried data (that is, to-be-queried content). Then, the query device may perform signature processing on the query information, and transmit the signed query information to the blockchain network as the data query request. After receiving the data query request, a network module in a blockchain node may perform verification processing on the data query request, and after determining that the verification succeeds, perform data query processing based on the block range included in the data query request. In an embodiment, the blockchain node that performs verification processing on the data query request is the computer device. In this case, the network module in the blockchain node is a network module in the computer device. When the blockchain node performs verification processing on the data query request, two verification processes are included, which are respectively: verifying signature information included in the data query request, and verifying a certificate of the signature information. In this way, through the two verification processes, the computer device can effectively ensure source security and reliability of the obtained data query request, so that data in the blockchain can be effectively prevented from being leaked, to ensure security of the blockchain data.

In an embodiment, after obtaining the data query request from the blockchain network, the computer device may perform signature verification processing on the data query request, and when the signature verification succeeds, obtain query suspension information of the block prefix sum array. The query suspension information indicates whether the obtained block prefix sum array supports obtaining of stored data. Therefore, after the computer device obtains the query suspension information, when the query suspension information indicates that query of the block prefix sum array is not suspended, the computer device may trigger an operation of determining, from the block prefix sum array, a first block prefix sum associated with a block height (i−1) and a second block prefix sum associated with a block height j. Then operation S404 is performed. If the query suspension information obtained by the computer device indicates that the query of the block prefix sum array is suspended, the computer device may store the obtained data query request in a query waiting queue, re-obtain the data query request from the query waiting queue when the block prefix sum array starts to support query, and perform data query processing with reference to the block prefix sum array.

A process in which the computer device (that is, the blockchain node) performs data query in the blockchain is a process in which the computer device performs high-performance blockchain range sum query in the blockchain network. In other words, the computer device is a system for performing high-performance blockchain range sum query in the blockchain network. In this case, in addition to the network module mentioned above, the computer device further includes several other processing modules. Details may be shown in FIG. 3D. An internal implementation of the computer device, each processing module included in the computer device, and interaction among the modules are described below with reference to FIG. 3D.

### (1) Network Module

The network module is responsible for processing communication between different nodes in the blockchain, including data transmission, receiving, and broadcasting. Each node can transmit and receive transactions, blocks, and other important information in the blockchain network by using the network module. In addition, the network module is further responsible for processing tasks such as network connection, node discovery, and data synchronization in the blockchain.

### (2) Verification Module

The verification module is a security defense line of the blockchain node, and includes two submodules:

1. A certificate verification module: responsible for verifying digital signatures of transactions and blocks, to ensure integrity of data and credibility of a source.

2. A permission verification module: responsible for checking whether a user or a node initiating a request has a corresponding permission, to perform a specific operation, such as transaction submission or data query.

### (3) Transaction Pool Module

The transaction pool (also referred to as an internal memory pool or a mem pool) is a data structure in the blockchain network and is configured to store a to-be-processed transaction that has not been packaged into a block. When a user submits a new transaction to the blockchain network, the transaction first enters the transaction pool. When preparing to generate a new block, the blockchain node selects a specific quantity of transactions from the transaction pool for packaging. The transaction pool helps improve a processing capability of the blockchain network, and may also be used as a policy, that is, transactions with relatively high costs may be preferentially selected for packaging, to increase a quantity of virtual resources obtained by packaging a block. Therefore, the transaction pool module is configured to manage all transactions that have not been packaged into the block, and may be responsible for receiving, verifying, and storing the transactions until the transactions are included in the new block. In addition, this module may be further responsible for a transaction sorting and selection process, to optimize block construction.

### (4) Query Module

The query module is a core module in embodiments of this disclosure, includes a plurality of submodules In an example, the query module is configured to perform value query within a range. The submodules included in the query module include the following modules.

1. Block prefix sum array storage module: configured to store a prefix sum array obtained through calculation, to quickly respond to range sum query. In an example, the block prefix sum array storage module further includes a historical prefix sum array storage module, a new block prefix sum array storage module (or a current prefix sum array storage module), and a pre-storage module for a new block prefix sum.

The historical prefix sum array storage module is configured to store a prefix sum array of historical block data, for long-term query. The new block prefix sum array storage module is configured to store a prefix sum array of latest block data, for quick query. The pre-storage module for a new block prefix sum is configured to temporarily store prefix sum data of a new block, and wait to be merged into new block prefix sum array storage. The prefix sum data of the new block that is temporarily stored does not support query processing, and a query service is provided only after the prefix sum data of the new block is merged into a new block prefix sum array or merged into a historical prefix sum array.

2. Block prefix sum array generation module: responsible for generating the prefix sum array of the new block.

3. Block prefix sum array merging module: responsible for merging the prefix sum array of the new block into the historical prefix sum array.

4. Block prefix sum array query module: responsible for processing a prefix sum array query request, and calculating and returning a range sum result.

### (5) Scheduling Module

The scheduling module is responsible for coordinating various activities of the blockchain node, and specifically includes:

1. Block generator: responsible for creating a new block, including selecting a transaction, executing a transaction, and constructing a block structure.

2. Transaction scheduling module: configured to manage an execution sequence and a priority of a transaction.

3. Contract warehouse: configured to store code and related data of a smart contract.

4. Contract process pool: configured to manage an execution environment and resource allocation of a smart contract.

### (6) Consensus Module

The consensus module is configured to implement a consensus algorithm of the blockchain, and is mainly responsible for reaching a consensus between nodes in the blockchain network and verifying and confirming validity of a transaction block. This module is a key part of blockchain security and decentralization.

### (7) Storage Module

The storage module is configured to persistently store all data of the blockchain, and includes the following two submodules.

1. Status database: configured to store a current status of the blockchain, such as a remaining electronic resource of an account or a state of a smart contract. Status data is a data structure in a blockchain system, and is configured for representing a current status of the system. The status data includes remaining electronic resources of all accounts, a state of the smart contract, and other related information. The status data is continuously updated as transactions are executed, and reflects a global status of the blockchain system at a specific time point. In the blockchain system, the status data is usually stored in a form of a Merkle tree or another encrypted data structure, to ensure integrity and security of the status data.

2. Block ledger: configured for storing a confirmed history of the blockchain, including all blocks and transaction records. The block ledger is a core data structure in the blockchain system, and is configured for storing and managing all confirmed blocks. The block ledger is organized in a chain structure. Each block includes a group of transactions, a block header (including metadata such as a hash value of a previous block and a timestamp), and other information. The block ledger provides a public and immutable historical transaction record for the blockchain system, to ensure transparency and consistency of the system.

The foregoing modules operate together to ensure that the blockchain node (that is, the computer device) can efficiently and securely process and store transaction data, and can provide a quick query service. In addition, based on such a modular design, the computer device can flexibly adapt to different blockchain network requirements, to achieve scalability and maintainability of embodiments of this disclosure.

S404: Obtain a block prefix sum array corresponding to the blockchain, the block prefix sum array including at least one block prefix sum, any block prefix sum being associated with a block height in the blockchain, and any block prefix sum being configured for storing block data of a block corresponding to the associated block height and block data of a block corresponding to a block height preceding the associated block height.

S405: Determine, from the block prefix sum array, the first block prefix sum associated with the block height (i−1) and the second block prefix sum associated with the block height j.

S406: Generate, based on block data stored in the first block prefix sum and block data stored in the second block prefix sum, block data that is requested to be queried by the data query request.

In operation S404 to operation S406, after obtaining the data query request, the computer device may further obtain the block prefix sum array corresponding to the blockchain, and when it is determined that the block prefix sum array supports the query service, the computer device separately determines, from the block prefix sum array, the first block prefix sum and the second block prefix sum based on the target block range indicated by the data query request, to determine, based on the determined first block prefix sum and second block prefix sum, the block data that is requested to be queried by the data query request. In an embodiment, the block prefix sum array corresponding to the blockchain may be a multi-level prefix sum array. The multi-level prefix sum array is an extension of the prefix sum array, and stores prefix sums on different levels, to adapt to query requirements of different granularities. For example, the 1^{st} level may store data of each block, the 2^{nd} level may store a sum of data of every 10 blocks, the 3^{rd} level may store a sum of data of every 100 blocks, and the like. In this structure, a most appropriate level may be selected for querying based on a size of a queried range, to optimize query efficiency. The multi-level prefix sum array mentioned in embodiments of this disclosure mainly includes a historical prefix sum array and a current prefix sum array (or a new prefix sum array or a relatively new prefix sum array). The historical prefix sum array includes at least one historical block prefix sum, and is stored in a persistent cache. The current prefix sum array includes at least one current block prefix sum, and is stored in a temporary cache.

In an embodiment, when the block prefix sum array includes the historical prefix sum array, when determining, from the block prefix sum array, the first block prefix sum associated with the block height (i−1) and the second block prefix sum associated with the block height j, the computer device may determine a maximum block height from a block height associated with each historical block prefix sum in the historical prefix sum array. The maximum block height may be referred to as a first maximum block height. If the determined first maximum block height is greater than or equal to j, it indicates that block data within the target block range [i, j] is stored in the historical block prefix sum in the historical prefix sum array. In this case, the computer device may determine, from the historical prefix sum array in the persistent cache, a historical block prefix sum associated with the block height (i−1) as the first block prefix sum. In addition, the computer device may determine, from the historical prefix sum array in the persistent cache, a historical block prefix sum associated with the block height j as the second block prefix sum, and may further determine, based on the first block prefix sum and the second block prefix sum, the block data that is requested to be queried by the data query request.

In another implementation, when determining, from the block prefix sum array, the first block prefix sum associated with the block height (i−1) and the second block prefix sum associated with the block height j, the computer device may first determine a minimum block height and a maximum block height from a block height associated with each current block prefix sum in the current prefix sum array. The maximum block height may be referred to as a second maximum block height. If the minimum block height determined by the computer device is less than i, and the second maximum block height determined by the computer device is greater than or equal to j, it indicates that the block data within the target block range [i, j] is stored in the current block prefix sum in the current prefix sum array. In this case, the computer device may determine, from the current prefix sum array in the temporary cache, a current block prefix sum associated with the block height (i−1) as the first block prefix sum. In addition, the computer device may determine, from the current prefix sum array in the temporary cache, a current block prefix sum associated with the block height j as the second block prefix sum, and may further determine, based on the first block prefix sum and the second block prefix sum, the block data that is requested to be queried by the data query request.

When the first block prefix sum and the second block prefix sum that are determined by the computer device are both determined from the historical prefix sum array, or are both determined from the current prefix sum array, when generating, based on the data stored in the first block prefix sum and the block data stored in the second block prefix sum, the block data that is requested to be queried by the data query request, the computer device may first obtain a sum of the block data stored in the first block prefix sum and a sum of the block data stored in the second block prefix sum, and then calculate difference data between the block data stored in the first block prefix sum and the block data stored in the second block prefix sum. Further, the computer device may use the difference data obtained through calculation as the block data that is requested to be queried by the data query request.

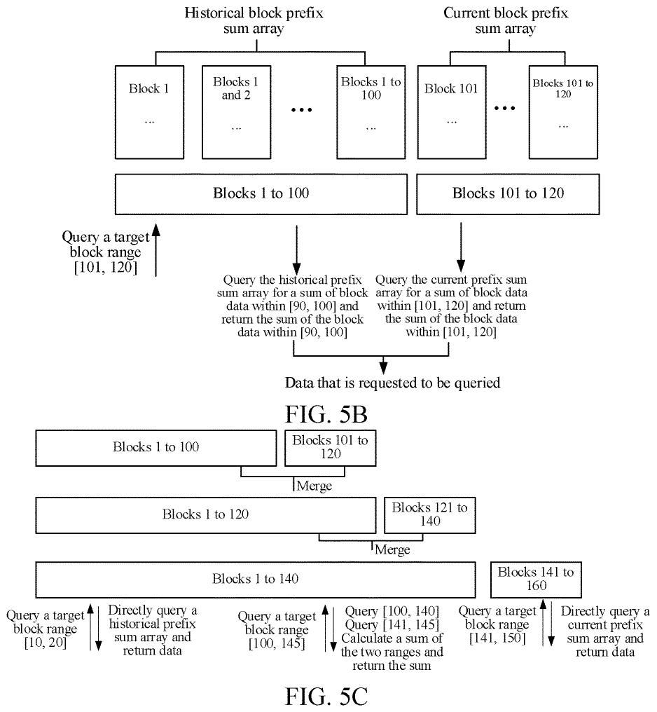

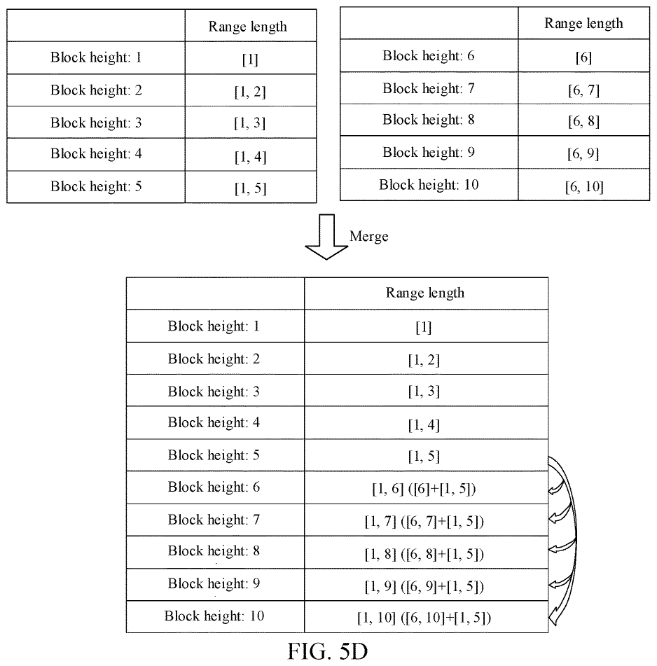

In an embodiment, the multi-level prefix sum array may be shown in FIG. 5A, the historical prefix sum array included in the multi-level prefix sum array is configured for recording prefix sums corresponding to block heights 1 to 100 in the blockchain, and the current prefix sum array is configured for recording prefix sums corresponding to block heights 101 to 120 in the blockchain. Based on the foregoing process of performing data query on the first block prefix sum and the second block prefix sum, with reference to FIG. 5A, if the target block range obtained by the computer device is [10, 20], the computer device may determine, based on the target block range [10, 20], that block data within the target block range is all recorded in the historical prefix sum array. Therefore, based on the target block range [10, 20], the computer device may obtain historical blocks 1 to 10 in the historical prefix sum array as the first block prefix sum, and obtain historical blocks 1 to 20 as the second block prefix sum, so that a difference between a sum of data recorded in the historical blocks 1 to 10 and a sum of data recorded in the historical blocks 1 to 20 can be used as data obtained through query. In another implementation, if the target block range obtained by the computer device is [102, 110], the computer device may determine, based on the target block range [102, 110], that block data within the target block range is all recorded in the current prefix sum array. Therefore, based on the target block range [102, 110], the computer device may obtain current blocks 101 and 102 in the current prefix sum array as the first block prefix sum, and obtain current blocks 101 to 110 as the second block prefix sum, so that difference data between a sum of data recorded in the current blocks 101 and 102 and a sum of data recorded in the current blocks 101 to 110 may be used as block data obtained through query.

In an embodiment, after the computer device determines the maximum block height (for example, the foregoing first maximum block height) from the block height associated with each historical block prefix sum in the historical prefix sum array, if the determined first maximum block height is greater than or equal to i and less than j, it indicates that the block data within the target block range [i, j] is respectively stored in the historical block prefix sum in the historical prefix sum array and the current block prefix sum in the current prefix sum array. In this case, the computer device respectively determines the first block prefix sum and the second block prefix sum from the historical prefix sum array and the current prefix sum array. In a specific implementation, because the first maximum block height determined by using the historical prefix sum array is greater than or equal to i, it indicates that the prefix sum associated with the block height (i−1) is the historical block prefix sum. Because the first maximum block height determined by using the historical prefix sum array is less than j, it indicates that the block prefix sum associated with the block height j is the current block prefix sum. Therefore, the computer device may determine, from the historical prefix sum array in the persistent cache, the historical block prefix sum associated with the block height (i−1) as the first block prefix sum; and the computer device may determine, from the current prefix sum array in the temporary cache, the current block prefix sum associated with the block height j as the second block prefix sum.

When the first block prefix sum and the second block prefix sum that are obtained by the computer device are respectively obtained from the historical prefix sum array and the current prefix sum array, when generating, based on the block data stored in the first block prefix sum and the block data stored in the second block prefix sum, the block data that is requested to be queried by the data query request, the computer device may first obtain a sum of block data stored in the historical block prefix sum associated with the first maximum block height, a sum of block data stored in the first block prefix sum, and a sum of block data stored in the second block prefix sum. Then the computer device may calculate difference data between the sum of the block data stored in the historical block prefix sum associated with the first maximum block height and the sum of the block data stored in the first block prefix sum. The difference data may be referred to as second difference data. The second difference data may be additional block data in the block data stored in the historical block prefix sum associated with the first maximum block height compared to the block data stored in the first block prefix sum. In addition, the computer device may obtain a sum of block data stored in the second block prefix sum. Then, a sum of the second difference data and the block data stored in the second block prefix sum may be used as the block data that is requested to be queried by the data query request. The block data that is requested to be queried includes the second difference data and the block data stored in the second block prefix sum.

In an embodiment, the multi-level prefix sum array is shown in FIG. 5B, prefix sums corresponding to block heights 1 to 100 in the blockchain are recorded in the historical prefix sum array, and prefix sums corresponding to block heights 101 to 120 in the blockchain are recorded in the current prefix sum array. In this case, if the target block range obtained by the computer device is [90, 110], the computer device may determine, based on the target block range [90, 110], that all block data within the target block range is respectively recorded in the historical prefix sum array and the current prefix sum array. Therefore, based on the target block range [90, 110], the computer device may obtain historical blocks 1 to 89 in the historical prefix sum array as the first block prefix sum, and obtain current blocks 101 to 110 as the second block prefix sum. Then, when determining the block data that is requested to be queried by the data query request, the computer device may obtain a sum of block data stored in the historical block prefix sum associated with the maximum block height, that is, obtain a sum of data recorded in history blocks 1 to 100; and obtain a first difference Δ1 based on the sum of the data recorded in the history blocks 1 to 100 and a sum of data recorded in history blocks 1 to 89, that is, obtain a sum of data within a block range of [90, 100]. In addition, the computer device may further obtain the sum of the block data stored in the second block prefix sum, that is, a sum Δ2 of data recorded in current blocks 101 to 120. Then, the computer device may use Δ1 and Δ2 as the block data that is requested to be queried by the data query request.

In an embodiment, because the historical prefix sum array is stored in the persistent cache, the current prefix sum array is stored in the temporary cache, and efficiency of responding to a query request from the temporary cache is high. Therefore, based on a caching manner of dividing the historical prefix sum array and the current prefix sum array in embodiments of this disclosure, efficiency of performing data query by the computer device based on a prefix sum array can be effectively improved. Meanwhile, embodiments of this disclosure further provide an example of merging historical block prefix sums in the historical prefix sum array and current block prefix sums in the current prefix sum array. In this way, the historical prefix sum array and the current prefix sum array may be constantly refreshed, to ensure timely storage of each current block prefix sum in the current prefix sum array, thereby effectively ensuring continuity of stored prefix sum data, and improving reliability and integrity of block data obtained through query by the computer device based on the prefix sum array.

In a multi-level block prefix sum array structure, updates of the historical prefix sum array and the current prefix sum array are generated when a merging moment is reached. In an example, the current block prefix sum in the current prefix sum array is merged into the historical prefix sum array when the merging moment is reached, and is stored as the historical prefix sum. In addition, the current prefix sum array also receives and stores a prefix sum of a newly generated block as a current block prefix sum. The merging moment includes: a moment at which a preset time threshold is reached, a moment at which a quantity of blocks included in the current prefix sum array reaches a quantity threshold, or the like. In this case, when the merging moment is reached, a process of merging the historical prefix sum array and the current prefix sum array may be shown in FIG. 5C and FIG. 5D.

In an embodiment, a block prefix sum of a new block received by the current prefix sum array is a prestored block prefix sum. When determining that there is the new block in the blockchain, the computer device may first obtain a target block on which consensus processing has been completed and a prestored prefix sum array; then, the computer device may further determine whether the prestored block prefix sum is in the prestored prefix sum array (e.g., exists in the prestored prefix sum array). If it is determined that no prestored block prefix sum exists in the prestored prefix sum array, block data of the target block may be stored as the 1^{st} prestored block prefix sum in the prestored prefix sum array. If the computer device determines that the prestored block prefix sum exists in the prestored prefix sum array, the computer device may obtain, from the prestored prefix sum array, a prestored block prefix sum with a maximum associated block height, and may obtain block data stored in the prestored block prefix sum with the maximum associated block height. Further, the computer device may perform merging processing on the obtained block data (that is, the block data stored in the prestored block prefix sum with the maximum associated block height) and the block data of the target block, and store merged block data as a new prestored block prefix sum in the prestored prefix sum array.

In an embodiment, neither the prestored block prefix sum nor the prestored prefix sum array provides a query service to the outside. Therefore, a query function can be implemented only after the prestored block prefix sum is merged into the current prefix sum array, and each prestored block prefix sum in the prestored prefix sum array may also be merged into the current prefix sum array when the merging moment is reached. In a specific implementation, the computer device may obtain a total quantity of prestored block prefix sums included in the prestored prefix sum array, to merge the prestored prefix sum array into the current prefix sum array when the total quantity meets a preset threshold. After merging the prestored prefix sum array into the current prefix sum array, the computer device uses the prestored prefix sum in the prestored prefix sum array as the current prefix sum in the current prefix sum array.

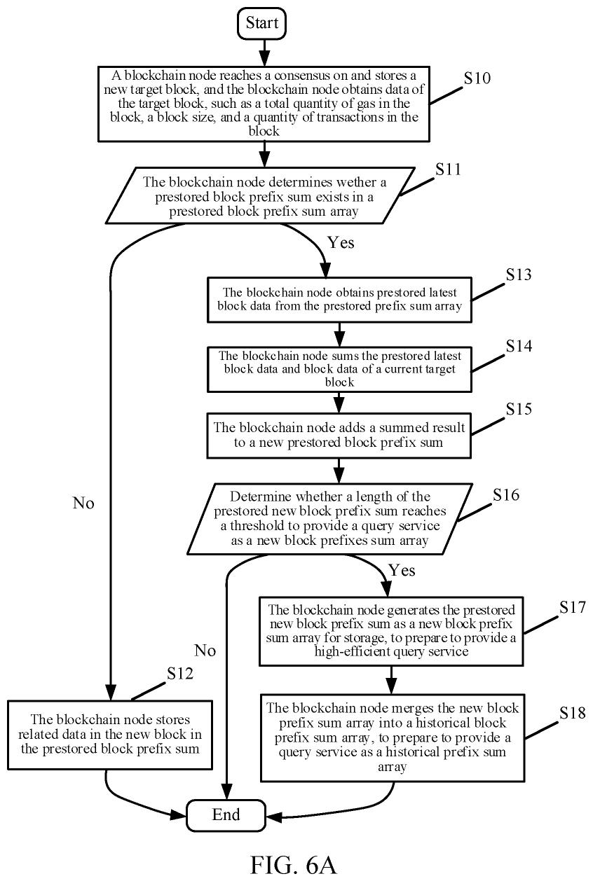

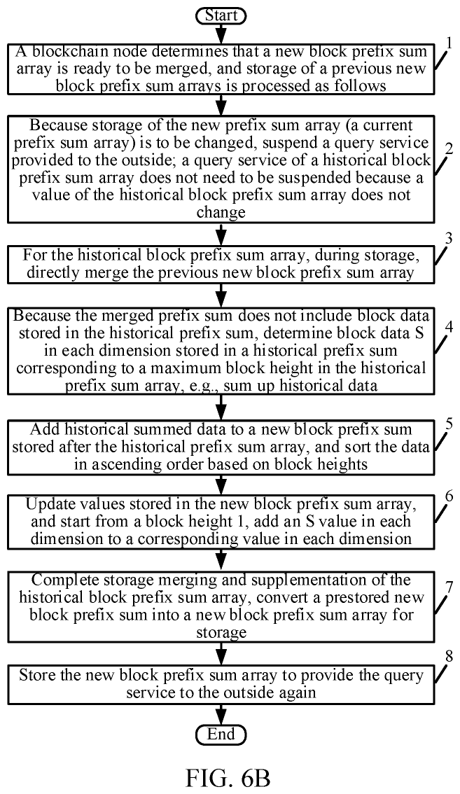

The following describes, with reference to FIG. 6A, a process in which after the computer device, as the blockchain node in the blockchain, determines that there is a new target block in the blockchain, the computer device first stores the target block in the prestored prefix sum, and then subsequently merges the target block into the current prefix sum array and the historical prefix sum array. When the computer device performs the process, the following operations are mainly included.

S10: Reach a consensus on and store the new target block, and obtain block data of the new block, including a total quantity of gas, a block size, a quantity of transactions in the block, and the like.

S11: Determine whether the prestored block prefix sum exists in a current prestored prefix sum array. If the prestored block prefix sum exists in the current prestored prefix sum array, operation S13 is performed; or if no prestored block prefix sum exists in the current prestored prefix sum array, operation S12 is performed.

S12: Store the block data of the target block in the prestored block prefix sum as the 1^{st} prestored block prefix sum in the prestored prefix sum array.

S13: Obtain prestored latest block data from the prestored prefix sum array.

S14: Sum the prestored latest block data and block data of a current target block.

S15: Use data obtained through summation as a new prestored block prefix sum, and store the new prestored block prefix sum in the prestored prefix sum array.

S16: Determine whether a quantity of prestored block prefix sums included in the current prestored prefix sum array reaches a threshold, and perform the following operation S17 when it is determined that the quantity reaches the threshold.

S17: Determine that the query service can be provided to the outside when it is determined that the threshold is reached, to merge the prestored block prefix sum into the current prefix sum array for storage, so as to prepare to provide a high-efficient quick query service.

S18: Merge each current block prefix sum in the current prefix sum array (or the new prefix sum array) into the historical block prefix sum array, to prepare to provide the query service.

For each current block prefix sum in the current prefix sum array and each historical block prefix sum in the historical prefix sum array, when the computer device merges each current block prefix sum in the current block prefix sum array into the historical block prefix sum array, the computer device may detect a trigger operation of merging the historical prefix sum array and the current prefix sum array, and obtain, from the historical prefix sum array, a historical block prefix sum with a maximum associated block height. Then, the computer device may obtain a sum of block data stored in the historical block prefix sum with the maximum associated block height, and merge the obtained sum of the block data into the current prefix sum array, to obtain an adjusted prefix sum array. Further, the computer device may store the adjusted prefix sum array in the persistent cache in which the historical prefix sum array is located. The trigger operation includes an operation of detecting that a quantity of current block prefix sums included in the current prefix sum array reaches a quantity threshold. When detecting the trigger operation of merging the historical prefix sum array and the current prefix sum array, the computer device may further suspend performing data query processing based on each current block prefix sum in the current prefix sum array.

In an embodiment, a specific process in which the computer device merges the prestored prefix sum into the current prefix sum array, and merges the current block prefix sum in the current prefix sum array as the historical range prefix sum may be shown in FIG. 6B, and specifically includes the following processes.

1: The blockchain node determines that each new block prefix sum (that is, the current block prefix sum) in the new prefix sum array (that is, the current prefix sum array) is to be merged, and determines that data stored in the current block prefix sum is to be adjusted.

2: Because storage content of the new prefix sum array is to be changed, the query service provided to the outside is suspended, while data stored in the historical prefix sum array does not change, and therefore, the query service of the historical prefix sum array does not need to be suspended.

3: For the historical prefix sum array, during storage, directly merge a previous new block prefix sum array.

4: Because the merged prefix sum does not include the block data stored in the historical prefix sum, first determine block data S in each dimension stored in the historical prefix sum corresponding to a maximum block height in the historical prefix sum array, that is, sum up all historical data.

5: Add all historical summed data to a new block prefix sum stored after the historical prefix sum array, and sort the data in ascending order based on block heights.

6: Update all values stored in the new block prefix sum array, and start from a block height 1, add an S value in each dimension to a corresponding value in each dimension, to obtain an adjusted prefix sum array.

7: Complete storage merging and supplementation of the historical block prefix sum array, and convert a prestored new block prefix sum into a new block prefix sum array for storage.

8: Store the new block prefix sum array to provide the query service to the outside again.

Based on the foregoing merging procedure, the current prefix sum array and the historical prefix sum array may be continuously updated. However, because the current prefix sum array is stored in the temporary cache, and the historical prefix sum array is stored in the persistent cache, it may be understood that the block prefix sum data stored in the temporary cache may be updated by updating the current prefix sum array, and the block prefix sum data in the persistent cache may be updated by updating the historical prefix sum array. In other words, the computer device implements periodic update processing on the temporary cache and the persistent cache. Based on the periodic update processing on the temporary cache and the persistent cache, timeliness of storing data in the temporary cache and the persistent cache can be ensured, so that reliability and accuracy of obtaining data from the temporary cache and the persistent cache by the computer device can be ensured.

Based on storage of the current prefix sum array and the historical prefix sum array by the computer device, the computer device implements a storage manner of collaborative hierarchical caching and persistent storage. Based on this storage manner, the computer device may implement a quick access policy for blockchain data, so that the computer device may optimize a range sum query process of a blockchain with reference to internal memory caching and persistent storage. In this access policy, a prefix sum array of a new block is first stored in a high-speed cache, to quickly respond to a query request of a latest block. As time passes by, the data is intelligently merged into a historical prefix sum array that is persistently stored, to provide support for querying in a longer time period. This hierarchical data management manner is used by the computer device, so that query efficiency of the computer device can be improved, data persistence and integrity are supported, and use efficiency of storage space of the computer device is optimized. The prefix sum arrays are intelligently merged and updated, so that this mechanism helps ensure real-time performance of data and high efficiency of query, reliance on an external database is reduced, and self-sufficiency and stability of the blockchain system are improved.

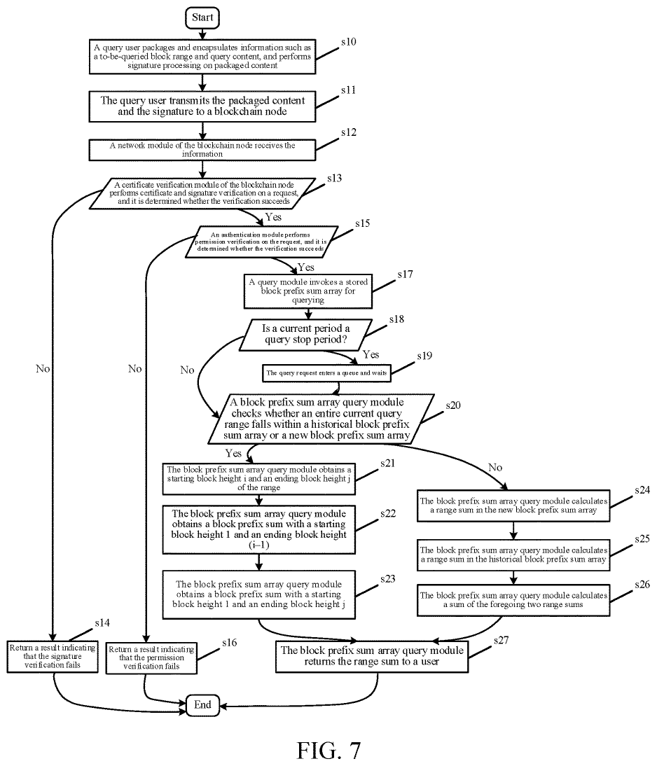

Based on update processing performed by the computer device on the temporary cache and the persistent cache, the computer device obtains block range data from the temporary cache and the persistent cache reliably and quickly. In this way, the computer device implements high-performance blockchain range sum based on multi-level prefix sum array storage. When the computer device implements range sum based on the multi-level prefix sum array storage, the system architecture shown in FIG. 3D may alternatively be used. The system architecture of the computer device includes a network module, a verification module, a transaction pool module, a query module, a scheduling module, a consensus module, and a storage module. The following describes, with reference to FIG. 7 and based on processing modules included in the computer device, a process in which the computer device, as a blockchain node, obtains block range data based on a temporary cache and a persistent cache. The following operations are specifically performed.

s10: A query user packages and encapsulates information such as a to-be-queried block range (that is, a target block range) and query content, and performs signature processing on packaged content.

s11: Transmit the signature and the packaged content to the blockchain node (that is, the computer device).

s12: The network module of the blockchain node receives the information, and determines that a data query request is obtained.

s13: The blockchain node performs certificate and signature verification, and when the verification succeeds, performs operation s15, or when the verification fails, starts to perform operation s14.

s14: Return a result indicating that the signature verification fails to the query user.

s15: Perform permission verification on the data query request by using an authentication module in the computer device, to determine whether the query user has a permission to obtain block range data from the blockchain; and when it is determined that the query user does not have the permission, perform operation s16; or when it is determined that the query user has the permission to obtain the data, perform operation s17.

s16: Return a result indicating that the permission verification fails to the query user.

s17: The computer device invokes, by using the query module, a block prefix sum array for querying.

s18: Determine whether a block prefix sum array providing a query service has stopped providing a query access service, if it is determined that the query access service is stopped, perform operation s19; or if it is determined that the query access service is not stopped, perform operation s20.

s19: Store the data query request in a waiting queue, and remain the data query request in the waiting queue until a to-be-queried block prefix sum array provides the query access service again.

s20: The computer device determines, by using a block prefix sum array query module and by using the data query request, whether an entire target query range falls within a historical block prefix sum array (that is, a historical prefix sum array) or a new block prefix sum array (that is, a current prefix sum array).

s21: If it is determined that the entire target query range falls within the historical block prefix sum array or the new block prefix sum array, the block prefix sum array query module obtains a starting block height i and an ending block height j corresponding to the range.

s22: The block prefix sum array query module obtains, from a prefix sum array, a block prefix sum with a starting block height 1 and a corresponding end block height i−1.

s23: The block prefix sum array query module obtains, from a prefix sum array, a block prefix sum with a starting block height 1 and a corresponding end block height j, and returns the obtained block prefix sum to the query user, to obtain queried block data.

s24: If it is determined that none of the entire target query range falls within the historical block prefix sum or the new block prefix sum, the block prefix sum array query module determines, based on the target block range, a range sum stored in the new block prefix sum array.

s25: The block prefix sum array query module determines, based on the target block range, a range sum stored in the historical block prefix sum array.

s26: Calculate a sum of the two range sums. In an example, the two range sums include the range sum stored in the new block prefix sum array and the range sum stored in the historical block prefix sum array.

s27: Return the obtained sum of the ranges to the query user, to obtain the queried block data.

Through a multi-level prefix sum array embedded in the blockchain, the computer device can achieve real-time and efficient range sum query of blockchain data, significantly improving query performance of the computer device in the blockchain, reducing system reliance, enhancing data real-time and system stability, providing a powerful data support for a plurality of fields such as financial analysis and supply chain follow-up, and further promoting widespread application and maximization of value of a blockchain technology. A system architecture of the computer device is a running basis of an entire environment, and a blockchain block prefix sum array structure, a blockchain block prefix sum array storage manner and calculation process, a blockchain block prefix sum array query procedure, a multi-level block prefix sum array query procedure, and a multi-level block prefix sum array merging and updating procedure are all implemented based on the system architecture. In this way, through the foregoing implementation and system architecture, it is ensured that the system runs efficiently and stably.

In embodiments of this disclosure, after obtaining query information, the query device may perform signature processing on the query information, and use the signed query information as the data query request and transmit the signed query information to the blockchain network. The computer device may obtain the data query request from the blockchain network, and determine, based on the data query request, the target block range for block sum data query to be performed. In addition, the blockchain further corresponds to a block prefix sum array. The block prefix sum array is stored, for example, in a manner of merging hierarchical cache and persistent storage. Therefore, after determining the target block range, the computer device may determine a corresponding block prefix sum from the current prefix sum array and the historical prefix sum array based on the target block range; and then determine, based on the determined block prefix sum, block data that is requested to be queried. Because of a hierarchical storage form of the block prefix sum array in the blockchain, the computer device may quickly obtain the corresponding block prefix sum from the stored prefix sum array, so that the computer device quickly responds to the queried block data, thereby improving data query efficiency.

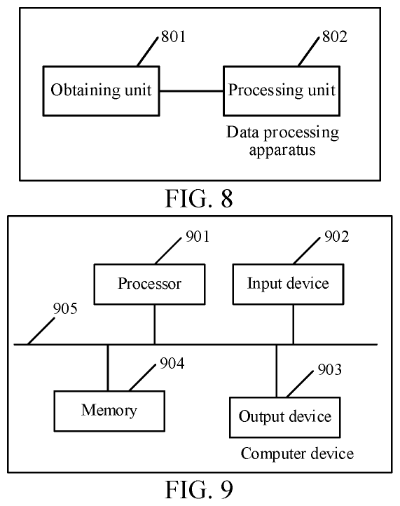

Based on the foregoing embodiments of the data processing method, embodiments of the present disclosure further provide a data processing apparatus. The data processing apparatus may be a computer program (including a program code) run on the foregoing computer device. The data processing apparatus may be configured to perform the data processing methods shown in FIG. 2 and FIG. 4. Referring to FIG. 8, the data processing apparatus includes: an obtaining unit 801 and a processing unit 802.

The obtaining unit 801 is configured to obtain a data query request, the data query request being configured for requesting to query block data located within a target block range [i, j] in a blockchain, both i and j indicating block heights, both i and j being positive integers, and j>i.

The obtaining unit 801 is further configured to obtain a block prefix sum array corresponding to the blockchain, the block prefix sum array including at least one block prefix sum, any block prefix sum being associated with a block height in the blockchain, and any block prefix sum being configured to store block data of a block corresponding to the associated block height and block data of a block corresponding to a block height preceding the associated block height.

The processing unit 802 is configured to determine, from the block prefix sum array, a first block prefix sum associated with a block height (i−1) and a second block prefix sum associated with a block height j.

The processing unit 802 is further configured to generate, based on block data stored in the first block prefix sum and block data stored in the second block prefix sum, block data that is requested to be queried by the data query request.

In an embodiment, the block prefix sum array includes a historical prefix sum array, and the historical prefix sum array includes at least one historical block prefix sum and is stored in a persistent cache. The processing unit 802 is further configured to:
determine a first maximum block height from a block height associated with each historical block prefix sum in the historical prefix sum array; and
determine, if the first maximum block height is greater than or equal to j, from the historical prefix sum array in the persistent cache, a historical block prefix sum associated with the block height (i−1) as the first block prefix sum, and determine, from the historical prefix sum array in the persistent cache, a historical block prefix sum associated with the block height j as the second block prefix sum.

In an embodiment, the block prefix sum array includes a current prefix sum array, the current prefix sum array includes at least one current block prefix sum and is stored in a temporary cache. The processing unit 802 is further configured to:
determine a minimum block height and a second maximum block height from block height associated with each current block prefix sum in the current prefix sum array; and
determine, if the minimum block height is less than i and the second maximum block height is greater than or equal to j, from the current prefix sum array in the temporary cache, a current block prefix sum associated with the block height (i−1) as the first block prefix sum, and determine, from the current prefix sum array in the temporary cache, a current block prefix sum associated with the block height j as the second block prefix sum.

In an embodiment, the processing unit 802 is further configured to:
calculate first difference data between the block data stored in the first block prefix sum and the block data stored in the second block prefix sum; and
use the first difference data as the block data that is requested to be queried by the data query request.

In an embodiment, the block prefix sum array further includes the current prefix sum array, and the current prefix sum array includes at least one current block prefix sum and is stored in the temporary cache. The processing unit 802 is further configured to: determine, if the first maximum block height is greater than or equal to i and less than j, from the historical prefix sum array in the persistent cache, a historical block prefix sum associated with the block height (i−1) as the first block prefix sum; and determine, from the current prefix sum array in the temporary cache, a current block prefix sum associated with the block height j as the second block prefix sum.

In an embodiment, the processing unit 802 is further configured to:
calculate second difference data between block data stored in a historical block prefix sum associated with the first maximum block height and block data stored in the first block prefix sum; and
use the second difference data and the block data stored in the second block prefix sum as the block data that is requested to be queried by the data query request.

In an embodiment, the obtaining unit 801 is configured to: obtain a target block on which consensus processing has been completed, and a prestored prefix sum array.

The processing unit 802 is further configured to: determine whether a prestored block prefix sum exists in the prestored prefix sum array; and store, if no prestored block prefix sum exists in the prestored prefix sum array, block data of the target block as the 1^{st} prestored block prefix sum in the prestored prefix sum array.

In an embodiment, the processing unit 802 is further configured to: obtain, if a prestored block prefix sum exists in the prestored prefix sum array, a prestored block prefix sum with a maximum associated block height from the prestored prefix sum array.

The processing unit 802 is further configured to merge block data stored in the prestored block prefix sum with the maximum associated block height and the block data of the target block, and store merged block data as a new prestored block prefix sum in the prestored prefix sum array.

In an embodiment, the processing unit 802 is further configured to: obtain a total quantity of prestored block prefix sums included in the prestored prefix sum array.

The processing unit 802 is further configured to: merge the prestored prefix sum into the current block prefix sum array if the total quantity meets a preset threshold.

In an embodiment, the block prefix sum array includes the historical prefix sum array and the current prefix sum array.

The processing unit 802 is further configured to: obtain, from the historical prefix sum array, a historical block prefix sum with a maximum associated block height when a trigger operation of performing merging processing on the historical prefix sum array and the current prefix sum array is detected.

The obtaining unit 801 is further configured to merge block data stored in the historical block prefix sum with the maximum associated block height into the current prefix sum array, to obtain an adjusted prefix sum array.

The processing unit 802 is further configured to store the adjusted prefix sum array in the persistent cache in which the historical prefix sum array is located.

In an embodiment, the trigger operation includes: detecting that a quantity of current block prefix sums included in the current prefix sum array reaches a quantity threshold. The processing unit 802 is further configured to:
suspend performing data query processing based on each current block prefix sum in the current prefix sum array.

In an embodiment, the data query request is obtained from a query device. In an example, a manner in which the query device generates the data query request includes:
obtaining, by the query device, query information, the query information including: a target block range within which to-be-queried data is located, and a data identifier of the to-be-queried data; and
performing, by the query device, signature processing on the query information, and transmitting the signed query information to the blockchain as the data query request.

In an embodiment, the processing unit 802 is further configured to: perform signature verification processing on the data query request; and obtain, when signature verification succeeds, query suspension information of the block prefix sum array.

The processing unit 802 is further configured to: trigger, when the query suspension information indicates that query of the block prefix sum array is not suspended, an operation of determining, from the block prefix sum array, the first block prefix sum associated with the block height (i−1) and the second block prefix sum associated with the block height j.

In embodiments of this disclosure, when the blockchain performs data query, the obtaining unit 801 may first obtain the data query request, so that the processing unit 802 may determine a target block range of to-be-queried data. In addition, the obtaining unit 801 may further obtain a block prefix sum array corresponding to the blockchain, so that the processing unit 802 may separately determine, from the block prefix sum array based on the target block range, a first block prefix sum and a second block prefix sum that are associated with the target block range. Based on determining of the first block prefix sum and the second block prefix sum by the processing unit 802, data requested by the data query request may be determined based on data stored in the first block prefix sum and data stored in the second block prefix sum. Therefore, the computer device implements quick query of block data within different block ranges in the blockchain based on the block prefix sum array, and improves efficiency of querying blockchain data. In addition, by querying the blockchain data based on the block prefix sum array, the processing unit 802 is enabled to obtain queried block data within constant time regardless of a size of the query range when querying data, to effectively reduce complexity of querying of the block data by the computer device. Based on effective improvement in efficiency and effective reduction in complexity of querying of the blockchain data by the computer device, stability and reliability of a system for querying of the blockchain data by the computer device can be effectively ensured.

FIG. 9 is a schematic block diagram of a structure of a computer device according to an embodiment of the present disclosure. The computer device is any node device in a blockchain. As shown in FIG. 9, the computer device in embodiments may include one or more processors 901, one or more input devices 902, one or more output devices 903, and a memory 904. The processor 901, the input device 902, the output device 903, and the memory 904 are connected through a bus 905. The memory 904 is configured to store a computer program that includes program instructions, and the processor 901 is configured to execute the program instructions stored in the memory 904.

The memory 904 may include a volatile memory, such as a random-access memory (RAM). The memory 904 may alternatively include a non-volatile memory, for example, a flash memory, or a solid-state drive (SSD). Alternatively, the memory 904 may include a combination of the foregoing memories.

The processor 901 may be a central processing unit (CPU). The processor 901 may further include a hardware chip. The foregoing hardware chip may be an application-specific integrated circuit (ASIC), a programmable logic device (PLD), or the like. The PLD may be a field-programmable gate array (FPGA), a generic array logic (GAL), or the like. The processor 901 may be a combination of the above structure.

In an embodiment of the present disclosure, the memory 904 is configured to store computer program that includes program instructions, and the processor 901 is configured to execute the program instructions stored in the memory 904, to implement the operations of the corresponding method shown in FIG. 2 and FIG. 4.

In an embodiment, the processor 901 is configured to invoke the program instruction, to perform the following operations:
obtaining a data query request, the data query request being configured to request to query block data located within a target block range [i, j] in a blockchain, both i and j indicating block heights, both i and j being positive integers, and j>i;
obtaining a block prefix sum array corresponding to the blockchain, the block prefix sum array including at least one block prefix sum, any block prefix sum being associated with a block height in the blockchain, and any block prefix sum being configured to store block data of a block corresponding to the associated block height and block data of a block corresponding to a block height preceding the associated block height;
determining, from the block prefix sum array, a first block prefix sum associated with a block height (i−1) and a second block prefix sum associated with a block height j; and
generating, based on block data stored in the first block prefix sum and block data stored in the second block prefix sum, block data that is requested to be queried by the data query request.

Embodiments of the present disclosure provide a computer program product or computer program. The computer program product or computer program includes computer instructions. The computer instructions are stored in a computer-readable storage medium. A processor of a computer device reads the computer instructions from the computer-readable storage medium, and the processor executes the computer instructions, so that the computer device performs the method embodiments shown in FIG. 2 and FIG. 4. The computer storage medium may be a magnetic disk, an optical disc, a read-only memory (ROM), a random access memory (RAM), or the like.

One or more modules, submodules, and/or units of the apparatus can be implemented by processing circuitry, software, or a combination thereof, for example. The term module (and other similar terms such as unit, submodule, etc.) in this disclosure may refer to a software module, a hardware module, or a combination thereof. A software module (e.g., computer program) may be developed using a computer programming language and stored in memory or non-transitory computer-readable medium. The software module stored in the memory or medium is executable by a processor to thereby cause the processor to perform the operations of the module. A hardware module may be implemented using processing circuitry, including at least one processor and/or memory. Each hardware module can be implemented using one or more processors (or processors and memory). Likewise, a processor (or processors and memory) can be used to implement one or more hardware modules. Moreover, each module can be part of an overall module that includes the functionalities of the module. Modules can be combined, integrated, separated, and/or duplicated to support various applications. Also, a function being performed at a particular module can be performed at one or more other modules and/or by one or more other devices instead of or in addition to the function performed at the particular module. Further, modules can be implemented across multiple devices and/or other components local or remote to one another. Additionally, modules can be moved from one device and added to another device, and/or can be included in both devices.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

In addition, the foregoing disclosure is some embodiments of the present disclosure, and certainly is not intended to limit the protection scope of the present disclosure. A person of ordinary skill in the art may understand that all or some of the processes in the foregoing embodiments, and make equivalent variations in accordance with the claims of the present disclosure shall fall within the scope of this disclosure.

What is claimed is:

1. A data processing method, comprising:
obtaining a data query request, the data query request being configured to query block data located within a target block range [i, j] in a blockchain, both i and j indicating block heights, both i and j being positive integers, and j>i;
obtaining a block prefix sum array corresponding to the blockchain, the block prefix sum array including at least one block prefix sum, each block prefix sum being associated with a respective block height in the blockchain, and each block prefix sum being configured to store block data of a block corresponding to the associated block height and block data of a block corresponding to a block height preceding the associated block height;
determining, from the block prefix sum array, a first block prefix sum associated with a block height (i−1) and a second block prefix sum associated with the block height j; and
generating, based on block data stored in the first block prefix sum and block data stored in the second block prefix sum, the block data located within the target block range [i, j] in the blockchain.

2. The method according to claim 1, wherein
the block prefix sum array includes a historical prefix sum array, the historical prefix sum array includes at least one historical block prefix sum, and the historical prefix sum array is stored in a persistent cache; and
the determining includes:
determining a first maximum block height from the block height associated with each historical block prefix sum in the historical prefix sum array; and
when the first maximum block height is greater than or equal to j, determining from the historical prefix sum array in the persistent cache, a historical block prefix sum associated with the block height (i−1) as the first block prefix sum, and determining, from the historical prefix sum array in the persistent cache, a historical block prefix sum associated with the block height j as the second block prefix sum.

3. The method according to claim 1, wherein
the block prefix sum array includes a current prefix sum array, the current prefix sum array includes at least one current block prefix sum, and the current prefix sum array is stored in a temporary cache; and
the determining includes:
determining a minimum block height and a second maximum block height from a block height associated with each current block prefix sum in the current prefix sum array; and
when the minimum block height is less than i and the second maximum block height is greater than or equal to j, determining from the current prefix sum array in the temporary cache, a current block prefix sum associated with the block height (i−1) as the first block prefix sum, and determining, from the current prefix sum array in the temporary cache, a current block prefix sum associated with the block height j as the second block prefix sum.

4. The method according to claim 1, wherein
the generating includes calculating first difference data between the block data stored in the first block prefix sum and the block data stored in the second block prefix sum; and
the first difference data is used as the block data that is queried by the data query request.

5. The method according to claim 2, wherein
the block prefix sum array further includes a current prefix sum array, the current prefix sum array includes at least one current block prefix sum, and the current prefix sum array is stored in a temporary cache; and
the method further comprises:
when the first maximum block height is greater than or equal to i and less than j, determining from the historical prefix sum array in the persistent cache, a historical block prefix sum associated with the block height (i−1) as the first block prefix sum; and
determining, from the current prefix sum array in the temporary cache, a current block prefix sum associated with the block height j as the second block prefix sum.

6. The method according to claim 5, wherein
the generating includes calculating second difference data between block data stored in a historical block prefix sum associated with the first maximum block height and block data stored in the first block prefix sum; and
the second difference data and the block data stored in the second block prefix sum are used as the block data that is queried by the data query request.

7. The method according to claim 1, further comprising:
obtaining a target block on which consensus processing has been completed and a prestored prefix sum array;
determining whether a prestored block prefix sum is in the prestored prefix sum array; and
storing, when no prestored block prefix sum are in the prestored prefix sum array, block data of the target block as the first prestored block prefix sum in the prestored prefix sum array.

8. The method according to claim 7, further comprising:
when the prestored block prefix sum is in the prestored prefix sum array,
obtaining a prestored block prefix sum with a maximum associated block height from the prestored prefix sum array;
merging block data stored in the prestored block prefix sum with the maximum associated block height and the block data of the target block; and
storing merged block data as a new prestored block prefix sum in the prestored prefix sum array.

9. The method according to claim 8, further comprising:
obtaining a total quantity of prestored block prefix sums in the prestored prefix sum array; and
merging the prestored prefix sum array into a current prefix sum array when the total quantity meets a preset threshold.

10. The method according to claim 5, wherein
the block prefix sum array includes the historical prefix sum array and the current prefix sum array, and
the method further comprises:
obtaining, from the historical prefix sum array, a historical block prefix sum with a maximum associated block height when a trigger operation of performing merging processing on the historical prefix sum array and the current prefix sum array is detected;
merging block data stored in the historical block prefix sum with the maximum associated block height into the current prefix sum array to obtain an adjusted prefix sum array; and
storing the adjusted prefix sum array in the persistent cache in which the historical prefix sum array is located.

11. The method according to claim 10, wherein
the trigger operation includes detecting that a quantity of current block prefix sums in the current prefix sum array reaches a quantity threshold; and
when the trigger operation is detected, the method further includes suspending performing data query processing based on each current block prefix sum in the current prefix sum array.

12. The method according to claim 1, wherein
the data query request is obtained from a query device, and
the method includes generating, by the query device, the data query request that includes:
obtaining, by the query device, query information including (i) a target block range within which to-be-queried data is located, and (ii) a data identifier of the to-be-queried data;
performing, by the query device, signature processing on the query information, and
transmitting the signed query information to the blockchain as the data query request.

13. The method according to claim 1, further comprising:
performing signature verification processing on the data query request; and
when signature verification succeeds,
obtaining query suspension information of the block prefix sum array; and
triggering, when the query suspension information indicates that query of the block prefix sum array is not suspended, an operation of determining, from the block prefix sum array, the first block prefix sum associated with the block height (i−1) and the second block prefix sum associated with the block height j.

14. The method according to claim 13, further comprising:
performing, when the signature verification succeeds, permission verification on the data query request to determine whether a query user has a permission to obtain the block data from the blockchain; and
triggering, when the permission verification succeeds, the operation of determining, from the block prefix sum array, the first block prefix sum associated with the block height (i−1) and the second block prefix sum associated with the block height j.

15. The method according to claim 13, further comprising:
storing, when the query suspension information indicates that query of the block prefix sum array is suspended, the data query request in a query waiting queue; and
re-obtaining the data query request from the query waiting queue when the block prefix sum array resumes providing a query access service, and performing data query processing based on the block prefix sum array.

16. A data processing device, comprising processing circuitry configured to:
obtain a data query request, the data query request being configured to query block data located within a target block range [i, j] in a blockchain, both i and j indicating block heights, both i and j being positive integers, and j>i;
obtain a block prefix sum array corresponding to the blockchain, the block prefix sum array including at least one block prefix sum, each block prefix sum being associated with a respective block height in the blockchain, and each block prefix sum being configured to store block data of a block corresponding to the associated block height and block data of a block corresponding to a block height preceding the associated block height;
determine, from the block prefix sum array, a first block prefix sum associated with a block height (i−1) and a second block prefix sum associated with the block height j; and
generate, based on block data stored in the first block prefix sum and block data stored in the second block prefix sum, the block data located within the target block range [i, j] in the blockchain.

17. The data processing device according to claim 16, wherein
the block prefix sum array includes a historical prefix sum array, the historical prefix sum array includes at least one historical block prefix sum, and the historical prefix sum array is stored in a persistent cache; and
the processing circuitry is configured to:
determine a first maximum block height from the block height associated with each historical block prefix sum in the historical prefix sum array; and
when the first maximum block height is greater than or equal to j, determine from the historical prefix sum array in the persistent cache, a historical block prefix sum associated with the block height (i−1) as the first block prefix sum, and determine, from the historical prefix sum array in the persistent cache, a historical block prefix sum associated with the block height j as the second block prefix sum.

18. The data processing device according to claim 16, wherein
the block prefix sum array includes a current prefix sum array, the current prefix sum array includes at least one current block prefix sum, and the current prefix sum array is stored in a temporary cache; and
the processing circuitry is configured to:
determine a minimum block height and a second maximum block height from a block height associated with each current block prefix sum in the current prefix sum array; and
when the minimum block height is less than i and the second maximum block height is greater than or equal to j, determine from the current prefix sum array in the temporary cache, a current block prefix sum associated with the block height (i−1) as the first block prefix sum, and determine, from the current prefix sum array in the temporary cache, a current block prefix sum associated with the block height j as the second block prefix sum.

19. The data processing device according to claim 16, wherein
the processing circuitry is configured to calculate first difference data between the block data stored in the first block prefix sum and the block data stored in the second block prefix sum; and
the first difference data is used as the block data that is queried by the data query request.

20. A non-transitory computer-readable storage medium storing instructions which when executed by at least one processor cause the at least one processor to perform:
obtaining a data query request, the data query request being configured to query block data located within a target block range [i, j] in a blockchain, both i and j indicating block heights, both i and j being positive integers, and j>i;
obtaining a block prefix sum array corresponding to the blockchain, the block prefix sum array including at least one block prefix sum, each block prefix sum being associated with a respective block height in the blockchain, and each block prefix sum being configured to store block data of a block corresponding to the associated block height and block data of a block corresponding to a block height preceding the associated block height;
determining, from the block prefix sum array, a first block prefix sum associated with a block height (i−1) and a second block prefix sum associated with the block height j; and
generating, based on block data stored in the first block prefix sum and block data stored in the second block prefix sum, the block data located within the target block range [i, j] in the blockchain.
